(19) United States
(12) Patent Application Publication
(10) Pub. No.: US 2003/0201903 A1
(43) Pub. Date: Oct. 30, 2003

(54) Remote illuminant multifunction controller

(75) Inventor: Chu Ping Shen, Taipei Hsien (TW)

Correspondence Address: BACON & THOMAS, PLLC, 625 SLATERS LANE, FOURTH FLOOR, ALEXANDRIA, VA, 22314

(73) Assignee: Advance Security Inc., Taipei Hsien (TW)

(21) Appl. No.: 10/121,687

(22) Filed: Apr. 15, 2002

(51) Int. Cl. G08B 5/22

(52) U.S. Cl. 340/815.45; 361/686; 340/693.5

(57) ABSTRACT

A remote illuminant multifunction controller including transmitter, illuminant switch and high brightness LED bulb. The high brightness LED bulb is built in front of the transmitter, together with the illuminant switch in the same side. The high brightness LED bulb can be simply switch on and off by using the illuminant switch. The control penal is built on top of the transmitter to control the sensed object. A user will be able to control the sensed object easily by using the present transmitter that is also a handy illuminant tool. The remote illuminant multifunction controller utilized and combined remote control and illuminant tools, hence to replace the traditional remote controller and torch.

### BACKGROUND OF THE INVENTION

The present invention is related to a remote illuminant multifunction controller including a high brightness LED bulb in which built in front of the transmitter. The illuminant switch is fitted on the side that allowed control of the high brightness LED bulb when projecting lights. The control penal is built on top of the transmitter to control the sensed object, hence to replace the traditional remote controller, allowed a multifunction controller with handy illuminant tool.

A normal remote controller usually fitted with a smaller LED bulb, where the bulb lights when the remote controller is activated. The LED bulb only wink for a second to confirm the signal has been sent. Accordingly, the winking LED illuminant will not be able to offer sufficient lighting when user intends to search objects or confirm direction under a dark condition. Moreover, use of torch will be inconvenient as to limited user's action with additional hand required.

The commercial design is a remote illuminant multifunction controller with a high brightness LED bulb and illuminant switch built in front. The control penal and illuminant switch can be activated jointly or separately when the power source transmitted from the battery supply. This will not only allowed signaling the sensed object, but also allowed the high brightness bulb projecting lights at the same time, hence, of user a compact, handy and convenient multifunctional controller with high brightness illumination and easy operate system.

The present invention can be best understood through the following description and accompanying drawings wherein.

### BRIEF DESCRIPTION OF THE DRAWINGS

FIG. 1 is a 3D view of the present invention.

FIG. 2 is an assembly view of the present invention.

FIG. 3 shows the IC board design of the present invention.

FIG. 4 shows a 3D view of conventional remote controller.

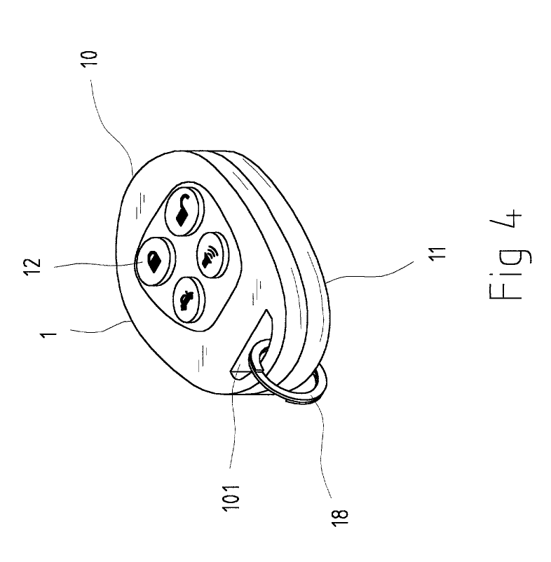

FIG. 5 shows an assembly view of conventional remote controller.

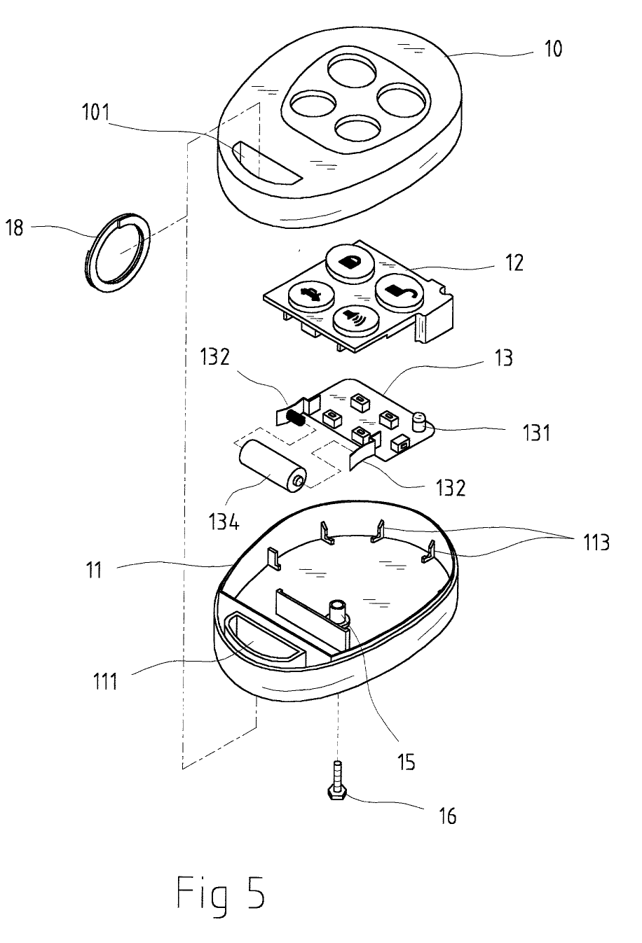

### DETAIL DESCRIPTION OF THE PREFERRED EMBODIMENTS

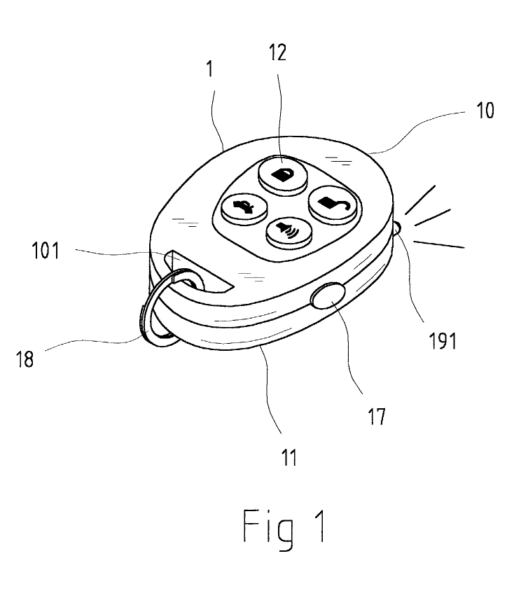

Please refer to FIGS. 1 to 3. The remote illuminant multifunction controller includes top cover (10), bottom cover (11), soft signal button (12), IC board (13) power supply (134), high brightness LED bulb (133) and illuminant switch (17).

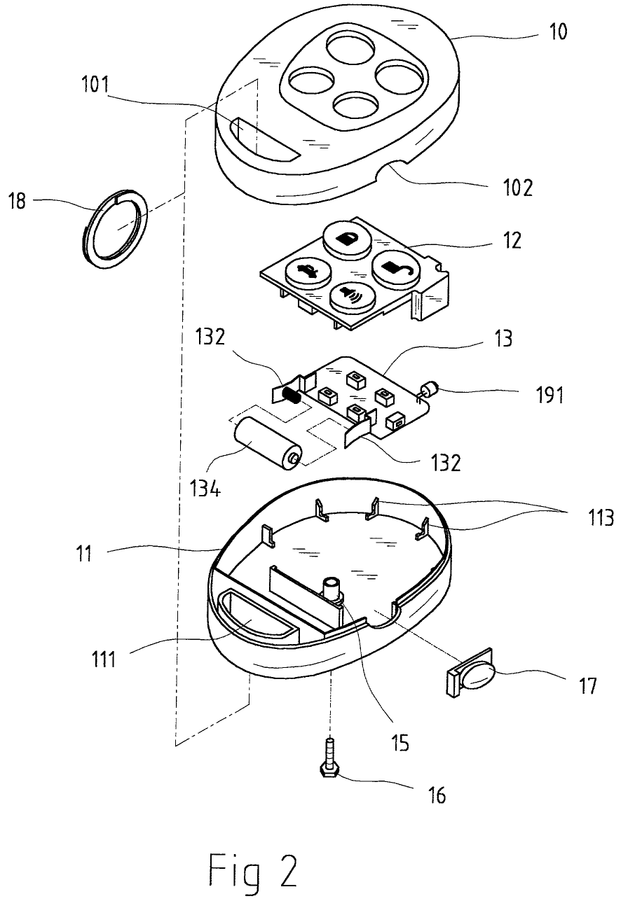

The top cover (10), as refer to FIGS. 1 and 2, is a plastic unit with inner notch space. The design of 4 circular holes on the surface is to fit with the soft signal button (12). The arc notch space (101) at the end connected to the other arc notch space (111) on bottom cover (11) alone with the ring (18). These two covers embedded with the screw hole (15) on the bottom cover (11) and the two side-notch spaces (101, 102) on both covers. The bottom cover (11) is designed in the same shape as the top cover (10) with exactly inner notch space. The screw hole (15) is designed to respond the top cover (10). Together, stand sets (113) is placed alone the inner side of bottom cover (11) to stabilize the IC board (13). The design of side notch space (112) on bottom cover (11) is to be combined with the other side notch space (102) in order to form a perfect circular hole which will allow the illuminant switch (17) to be placed within.

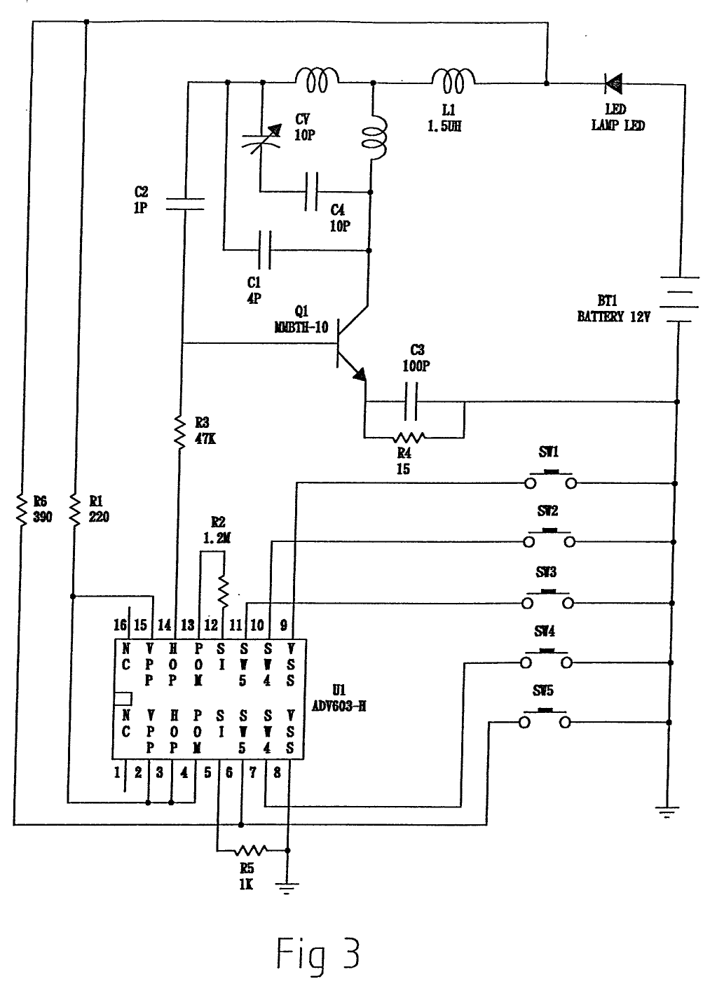

The soft signal button (12) is made from soft robber material. The IC board (13) is a board spreading with wires (as refer to FIG. 3), together with default transmission control button (as refer to FIG. 2). The high brightness LED bulb (133) is connected to the front of the IC board (13), and the power is connected to the power connector (132) in the back of the IC board (13) allow the power supply (134) to form the electricity circulation.

The above embodiment is only used to illustrate the present invention, not intended to limit the scope thereof. Many modifications of the above embodiment can be made without departing from the spirit of present invention.

### SUMMARY OF INVENTION

It is therefore a primary objective of the present invention to provide a remote illuminant multifunction controller. User will be allowed a compact, handy and convenient multifunctional tool when carrying with the transmitter.

The further objective of present invention to provide the above remote illuminant multifunction controller which is designed with IC board so that power supply is sharing in between control penal and high brightness LED bulb jointly. There is no additional power source required, as the power source can be fitted inside the transmitter unit. The required battery is the normal 12V type; hence enhance the compatibility and convenience to the usage.

The remote illuminant multifunction controller includes top cover (10), bottom cover (11), soft signal button (12), IC board (13), power supply (134), high brightness LED bulb (133) and illuminant switch (17).

The top cover (10), as refer to FIGS. 1 and 2, is a plastic unit with inner notch space. The design of 4 circular holes on the surface is to fit with the soft signal button (12). The arc notch space (101) at the end connected to the other arc notch space (111) on bottom cover (11) alone with ring (18). These two covers embedded with the screw hole (15) on the button cover (11) and the two side-notch spaces (101, 102) on both covers. The bottom cover (11) is designed in the same shape as the top cover (10) with exactly inner notch space. The screw hole (15) is designed to respond the top cover (10). Together, stand sets (113) is placed alone the inner side of bottom cover (11) to stabilize the IC board (13). The design of side notch space (112) on bottom cover (11) is to be combined with the other side notch space (102) in order to form a perfect circular hole which will allow the illuminant switch (17) to be placed within.

The soft signal button (12) is made from soft robber material. The IC board (13) is a board spreading with wires (as refer to FIG. 3), together with default transmission control button (as refer to FIG. 2). The high brightness LED bulb (133) is connected to the front of the IC board (13), and the power is connected to the power connector (132) in the back of the IC board (13) allow the power supply (134) to form the electricity circulation.

According to the above objectives, the remote illuminant multifunction controller (refer to FIG. 2). A normal 12V type battery is required to support the IC board (13) and power connector (132) in order to form the electricity circulation. Signal can be simply sent by pressing the soft signal button (12) on the transmitter (1). The soft signal button (12) activates the electrical circulation sending signals to the sensed object, together with winking of the high brightness LED bulb (133) to confirm that the signal has been sent through.

In addition, the high brightness LED bulb can be switched on by turning on the illuminant switch (17) at the same time to offer sufficient illumination. On the other hand, the high brightness LED bulb can also be switched off by simply by turning off the illuminant switch (17). The present invention enable user a compact and convenient tool of remote controlling and sufficient illumination without require of additional power supply, hence utilized and combined remote control and illuminant tools in replace of the traditional remote controller and any handy torch.

Furthermore, the high brightness LED bulb (133) that adopted in the present invention is compact and economic. It doesn't require high voltage of power supply nor heat up after a long time usage. The lighting produced by the high brightness LED bulb (133) is projected in a flat form and concentrated, allow user sufficient illumination in the dark condition, hence a utility and economic design.

The above embodiment is only used to illustrate the present invention, not intended to limit the scope thereof. Many modifications of the above embodiment can be made without departing from the spirit of present invention.

What is claimed is

1. The remote illuminant multifunction controller includes top cover, bottom cover, soft signal button, IC board, power supply, high brightness LED bulb and illuminant switch.

2. The remote illuminant multifunction controller as claimed in claim 1, wherein the high brightness LED bulb is fitted on the IC board together to form the transmitter. The illuminant switch is able to activate/deactivate the high brightness LED bulb and sending signals at the same time, also supported with the same power source as the IC board.
